(19) United States
(12) Patent Application Publication
(10) Pub. No.: US 2019/0172426 A1
(43) Pub. Date: Jun. 6, 2019

(54) Information Display Method and Terminal

(71) Applicant: Huawei Technologies Co., Ltd., Shenzhen (CN)

(72) Inventor: Jing Ni, Beijing (CN)

(73) Assignee: Huawei Technologies Co., Ltd., Shenzhen (CN)

(21) Appl. No.: 16/313,798

(22) PCT Filed: Jun. 26, 2017
(86) PCT No.: PCT/CN2017/090079

§ 371 Date: Dec. 27, 2018

(30) Foreign Application Priority Data
Jun. 30, 2016 (CN) 201610514958.1

(51) Int. Cl. G09G 5/391; G06T 7/50; G09G 5/10; G09G 5/373

(52) U.S. Cl. CPC G09G 5/391; G06T 7/50; G09G 5/10; G09G 5/373; G06K 9/00288; G09G 2320/0626; G09G 2340/04; G09G 2320/08; G09G 2354/00; G06T 2207/30201

(57) ABSTRACT

An information display method and a terminal, where the method includes detecting a distance between a terminal screen and a face, displaying first content when the distance between the terminal screen and the face satisfies a first distance condition, and displaying second content when the distance between the terminal screen and the face satisfies a second distance condition, where the first content and the second content are at least partially different. Hence, the method and the terminal resolve a problem that a display manner of the terminal is monotonous, and different content cannot be displayed based on a user requirement. The method can be used in various terminal devices, such as a personal computer and a smartphone.

### TECHNICAL FIELD

The present invention relates to the field of electronic device application, and in particular, to information display on a terminal.

### BACKGROUND

With rapid development of Internet technologies, a relationship between terminals and people is becoming closer, and a degree of terminal homogenization (which means that product differentiation is small) is also becoming higher. For example, when a user uses a terminal, content displayed on the terminal is always preset content.

Using a smartphone as an example, currently a display manner of the smartphone is usually as follows: When a user uses the smartphone, content is normally displayed on the smartphone; when the user does not use the smartphone within a period of time, the smartphone is in a lock screen state; when the user does not use the smartphone for a longer time, the smartphone is in a screen-off state. A specific lock screen time and screen-off lime may be configured by the user. In such a display manner, display content is very monotonous, and it is not beneficial for protection of personal privacy.

With rapid popularization of intelligent terminals and the mobile Internet, an intelligent terminal includes a growing amount of personal privacy, for example, includes an account number and a password for quick payment and an account number and a password of an online bank. An existing terminal display manner is not beneficial for protection of personal privacy.

An existing method that can change the terminal display manner is that: An intelligent terminal may detect whether light is incident by using an optical sensor and the like, and if light is incident, the intelligent terminal performs normal display; or if no light is incident, a screen is in a screen-off state. This solution can implement that a terminal screen is in the screen-off state because light incident to a terminal is blocked by an ear during a call, thereby greatly saving electric energy of the terminal. According to this method, a problem that display content of the terminal is monotonous cannot be resolved, different content cannot be intelligently displayed based on user requirements, and a problem of protection of personal privacy of users cannot be resolved.

### SUMMARY

This application provides an information display method and a terminal, to resolve a problem that display content of a terminal is monotonous and different content cannot be displayed based on a user requirement.

According to a first aspect, an embodiment of this application provides an information display method, where the method is performed by an electronic terminal. The method includes: detecting a distance between a terminal screen and a face; displaying first content when determining that the distance between the terminal screen and the face satisfies a first distance condition; and displaying second content when determining that the distance between the terminal screen and the face satisfies a second distance condition, where the first content and the second content are at least partially different. According to a second aspect, an embodiment of this application provides a terminal, where the terminal includes a distance detection unit and a processing unit. The distance detection unit is configured to detect a distance between a terminal screen and a face. The processing unit is configured to: display first content when determining that the distance between the terminal screen and the face satisfies a first distance condition; and display second content when determining that the distance between the terminal screen and the face satisfies a second distance condition, where the first content and the second content are at least partially different.

In embodiments of this application, display content is adjusted based on different distances between the face and the terminal screen, thereby enriching an existing display manner and interaction manner of the terminal.

In a design of this application, before the detecting a distance between a terminal screen and a face, the method further includes: recognizing, by a facial recognition apparatus disposed on the terminal, whether an image captured by a camera of the terminal includes a face.

In a design of this application, before the facial recognition apparatus recognizes whether the captured image includes the face, the method includes: detecting whether the terminal screen is on, and starting the facial recognition apparatus of the terminal in a screen-on state of the terminal screen.

In a design of this application, before the detecting a distance between a terminal screen and a face, the method includes: when the terminal is in a working mode, providing a user with a setting for enabling and disabling a function of detecting a distance between a terminal screen and a face and displaying different content based on different distances; or providing a user with a setting for enabling and disabling a function, in one or more mobile phone applications, of detecting a distance between a terminal screen and a face and displaying different content based on different distances.

In a design of this application, when the terminal is in a working mode or a lock screen mode, if the distance between the terminal screen and the face is within a preset distance range, the terminal performs normal display; or if the distance between the terminal screen and the face is beyond a preset distance range, the terminal displays corresponding content based on a preset condition.

In a design of this application, when the terminal is in a working mode or a lock screen mode, if the distance between the terminal screen and the face is within a preset distance range, the terminal performs normal display; or if the distance between the terminal screen and the face is beyond a preset distance range, the terminal reduces display content, reduces display brightness, or reduces a display resolution based on a preset condition.

In a design of this application, when the terminal is in a working mode, if the distance between the terminal screen and the face is within a preset distance range, the terminal performs normal display; or if the distance between the terminal screen and the face is beyond a preset distance range, the terminal scales up display content, or scales up a display font based on a preset condition.

In a design of this application, when the terminal is in a working mode, if the distance between the terminal screen and the face is within a preset distance range, the terminal performs normal display; or if the distance between the terminal screen and the face is beyond a preset distance range, the terminal reduces display content, or scales down a display font based on a preset condition.

In a design of this application, if the distance between the terminal screen and the face is beyond a preset distance range, the terminal performs normal display; or if the distance between the terminal screen and the face is within a preset distance range, the terminal displays more detailed content.

In a design of this application, if the distance between the terminal screen and the face is less than a first preset distance, the terminal displays the first content; if the distance between the terminal screen and the face is greater than the first preset distance and less than a second preset distance, the terminal displays the second content; or if the distance between the terminal screen and the face is greater than the second preset distance, the terminal displays third content, where the first content, the second content, and the third content are at least partially different.

In a design of this application, the detecting a distance between a terminal screen and a face includes: if detecting that there are a plurality of faces, calculating a distance between each face and the terminal screen, and using a minimum distance value as the distance between the terminal screen and the face.

In a design of this application, if one or more faces are detected, if it is determined that at least one of all the faces matches one or more preset faces, normal display is performed; and if it is determined that no face matches one or more preset faces, the corresponding content is displayed based on the preset condition.

In a design of this application, before the detecting a distance between a terminal screen and a face, the method includes: detecting whether there are one or more faces, if detecting that there are one or more faces, determining whether at least one of all the faces matches the one or more preset faces, and if at least one of all the faces matches the one or more preset faces, performing the detecting a distance between a terminal screen and a face; otherwise, displaying the corresponding content based on the preset condition.

In a design of this application, after the detecting a distance between a terminal screen and a face, the method includes: if detecting that the distance between the terminal screen and the face is within the preset distance range, determining whether at least one of all the faces matches the one or more preset faces, and if at least one of all the faces matches the one or more preset faces, performing normal display; or if determining that no face matches the one or more preset faces, displaying the corresponding content based on the preset condition.

In a design of this application, after the detecting a distance between a terminal screen and a face, if the distance is within the preset distance range, whether at least one face matches the one or more preset faces is determined, and if it is determined that no face matches the one or more preset faces, the corresponding content is displayed based on the preset condition; or if at least one face matches the one or more preset faces, the distance between the face and the terminal screen is determined, and if the distance is within the preset distance range, normal display is performed; or if the distance is beyond the preset distance range, the corresponding content is displayed based on the preset condition.

According to this application, the terminal displays different interface content based on different distances between a user face and a screen, existing display manners and interaction manners of an intelligent terminal device are enriched, and the display content is diversified, thereby improving user experience.

### BRIEF DESCRIPTION OF DRAWINGS

FIG. 1 is a flowchart of an information display method of a terminal according to an embodiment of this application;

FIG. 2 is a schematic diagram of picture comparison between different display content when distances between a terminal screen and a face are different according to an embodiment of this application;

FIG. 3 is another schematic diagram of picture comparison between different display content when distances between a terminal screen and a face are different according to an embodiment of this application; and

FIG. 4 is a schematic diagram of a terminal according to an embodiment of this application.

### DESCRIPTION OF EMBODIMENTS

The following describes the embodiments of this application with reference to accompanying drawings.

In embodiments of this application, a distance between a screen of a terminal and a face is detected, and the terminal displays different content based on different ranges of the distance. For example, when the distance between the terminal screen and the face is less than a predetermined value, the terminal displays one content; or when the distance between the terminal screen and the face is greater than the predetermined value, the terminal displays another content. Therefore, in the embodiments of this application, display content is diversified, and different requirements of different users can be satisfied. For example, for a user performing monotonous work with a terminal, the work may be more entertaining when different content is displayed based on different distances between the terminal screen and the face. For another example, for a user that operates a privacy-related transaction with an intelligent terminal, leakage of private content can be prevented by setting that display is normal only within a distance range, thereby improving security.

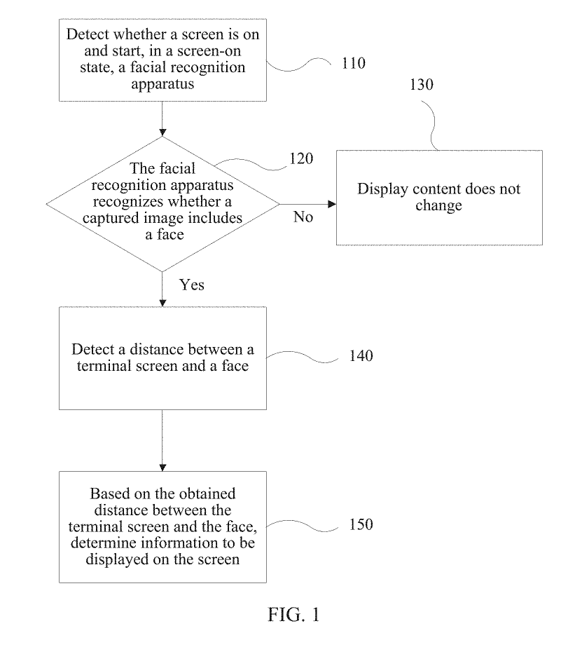

FIG. 1 is a flowchart of an information display method of a terminal according to an embodiment of this application. The information display method is performed by a terminal, such as a smartphone, a tablet computer, a notebook computer, a netbook, or a personal computer.

Step 110: Detect whether a screen of a terminal is on and start, in a screen-on state of the terminal screen, a facial recognition apparatus disposed on the terminal. In addition, step 110 is an optional step.

Step 120: The facial recognition apparatus recognizes whether an image captured by a camera of the terminal includes a face. Step 120 is an optional step.

Step 130: If the facial recognition apparatus recognizes that the image captured by the camera of the terminal does not include a face, the terminal skips changing display content.

Step 140: If the facial recognition apparatus recognizes that the image captured by the camera of the terminal includes a face, detect a distance between the terminal screen and the face.

In an example, when it is determined that a face squarely faces the screen, a sensor disposed on the terminal is started, and the distance between the face and the terminal screen is obtained by using the sensor.

Further, the sensor disposed on the terminal is a ranging sensor or a displacement sensor. For example, the ranging sensor disposed on the terminal is started, and a distance to an obstacle is detected by using the ranging sensor, thereby obtaining the distance between the face and the terminal screen.

Further, the sensor is an infrared ranging sensor, an ultrasonic sensor, a laser ranging sensor, or the like.

Using an example in which the sensor is an infrared ranging sensor, the following describes in detail in this embodiment of this application how to recognize that a face squarely faces the terminal screen, and how to detect a distance between the face and the terminal screen after the face is recognized.

First, the camera of the terminal (such as a front camera on the terminal) obtains an image squarely facing the terminal screen. The facial recognition apparatus of the terminal recognizes the image, and when recognizing that the image includes a face image, stalls the infrared ranging sensor disposed on the terminal. The infrared ranging sensor performs distance detection by using a principle that an infrared signal has different reflection intensity for obstacles in different distances. The infrared ranging sensor has an infrared signal transmit diode and an infrared signal receive diode. The infrared signal transmit diode is configured to transmit an infrared signal of a particular frequency. The infrared signal receive diode is configured to receive the infrared signal of the particular frequency. When the infrared ranging sensor encounters an obstacle in a transmit direction of the infrared signal, the infrared signal is reflected back and received by the infrared signal receive diode. Then, reflection intensity of the infrared signal is obtained based on the received infrared signal and transmitted infrared signal. Then, a terminal processor converts the reflection intensity of the infrared signal into a distance value, and then saves the distance value into a memory of the terminal.

In an example, when detecting that the image obtained by the camera of the terminal includes a plurality of faces, the facial recognition apparatus calculates a distance between each face and the terminal screen, and uses one of all the distances as the distance between the terminal screen and the face.

Further, a minimum value of the calculated distances between each face and the terminal screen is used as the distance between the terminal screen and the face.

In another example, the terminal stores one or more face images, for example, stores a face image of a user of the terminal. When the facial recognition apparatus detects that an image obtained by the camera of the terminal includes a face image, the facial recognition apparatus determines whether the face image obtained by the camera matches the face image stored in the terminal, that is, determines whether the face images are a same face. For example, the facial recognition apparatus recognizes whether the obtained face image is the face image of the user of the terminal stored in the terminal, and if yes, normal display is performed; or if not, corresponding content is displayed based on a preset condition.

Step 150: Based on the obtained distance between the terminal screen and the face, display first content when determining that the distance between the terminal screen and the face satisfies a first distance condition; and display second content when determining that the distance between the terminal screen and the face satisfies a second distance condition, where the first content and the second content are at least partially different.

In an example, the user is provided with a setting for the following system function: when the terminal is in a working mode, the user is provided with a setting for enabling and disabling a function of detecting a distance between a terminal screen and a face and displaying different content based on different distances; or the user is provided with a setting for enabling and disabling a function, in one or more mobile phone applications (such as a WeChat APP and a mobile banking APP), of detecting a distance between a terminal screen and a face and displaying different content based on different distances.

Further, the user is provided with a setting for selecting the following functions: (1) Display content is completely different if distances between the terminal screen and the face are different; (2) display content is partially different if distances between the terminal screen and the face are different; (3) display scales are different if distances between the terminal screen and the face are different.

In this embodiment of the present invention, a preset distance is configured on the terminal, and the display content of the terminal is determined by using a value relationship between the preset distance and the distance between the terminal screen and the face. The following provides detailed descriptions.

In an example, when the terminal is in a working mode or a lock screen mode, if the distance between the terminal screen and the face is within a preset distance range, the terminal performs normal display; or if the distance between the terminal screen and the face is beyond a preset distance range, the terminal displays corresponding content based on a preset condition. Refer to Table 1 below:

TABLE 1

| Relationship between a distance X | |
|---|---|
| (unit: centimeter) between a terminal | |
| screen and a face and a preset | |
| distance N (unit: centimeter) | Display content of a terminal |
| Distance X between the terminal screen | Perform normal display |
| and the face ≤ the preset distance N | |
| Distance X between the terminal screen | Display preset content |
| and the face > the preset distance N | |

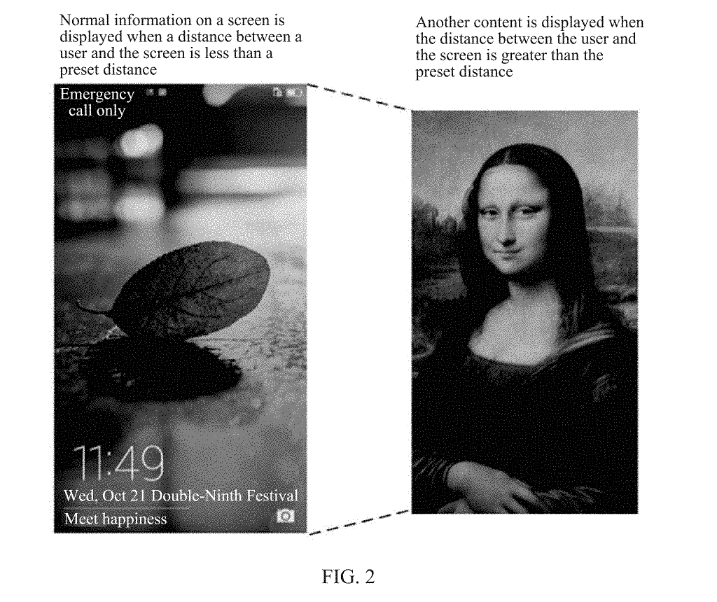

It can be learned from Table 1 that, after the distance X between the terminal screen and the face is obtained, the distance X is compared with the preset distance N configured on the terminal, and when the distance X between the terminal screen and the face is less than or equal to the preset distance N, normal display is performed, to be specific, content that is being displayed on the terminal is displayed. When the distance X between the terminal screen and the face is greater than the preset distance N, the corresponding content is displayed based on the preset condition, that is, the preset content is displayed. For example, a preset picture stored on the terminal is displayed. Refer to FIG. 2.

In FIG. 2, the left picture is an interface showing that the terminal performs normal display when the distance X between the terminal screen and the face is less than or equal to the preset distance N, and the right picture is an interface showing that a preset picture is displayed when the distance X between the terminal screen and the face is greater than the preset distance N. A person skilled in the art may understand that, the left picture and the right picture in FIG. 2 display only an example of displaying a picture.

It can be learned from this that, when the obtained distance X between the terminal screen and the face is within a range of the preset distance N, normal display is performed; and once the distance X between the terminal screen and the face exceeds the preset distance N, the corresponding content is displayed based on the preset condition. Therefore, this embodiment of the present invention can effectively prevent leakage of personal privacy.

In another example, when the terminal is in a working mode or a lock screen mode, if the distance between the terminal screen and the face is within a preset distance range, the terminal performs normal display; or if the distance between the terminal screen and the face is beyond a preset distance range, the terminal reduces display content, reduces display brightness, or reduces a display resolution based on a preset condition. Refer to Table 2 below;

TABLE 2

| Relationship between a distance X | |
|---|---|
| (unit: centimeter) between a terminal | |
| screen and a face and a preset | |
| distance L (unit: centimeter) | Display content of a terminal |
| Distance X between the terminal screen | Perform normal display |
| and the face ≤ the preset distance L | |
| Distance X between the terminal screen | Reduce display content, reduce |
| and the face > the preset distance L | display brightness, or reduce a |
| | display resolution |

It can be learned from Table 2 that, after the distance X between the terminal screen and the face is obtained, the distance X is compared with the preset distance L configured on the terminal, and when the distance X between the terminal screen and the face is less than or equal to the preset distance L, normal display is performed, to be specific, content that is being displayed on the terminal is displayed. When the distance X between the terminal screen and the face is greater than the preset distance L, display content is reduced, display brightness is reduced, or a display resolution is reduced based on a preset condition.

It can be learned from this that, when the obtained distance X between the terminal screen and the face is within a range of the preset distance L, normal display is performed; and once the distance X between the terminal screen and the face exceeds the preset distance L, the display content is reduced, the display brightness is reduced, or the display resolution is reduced. Therefore, this embodiment of the present invention can effectively prevent leakage of personal privacy.

In still another example, when the terminal is in a working mode, if the distance between the terminal screen and the face is within a preset distance range, the terminal performs normal display; or if the distance between the terminal screen and the face is beyond a preset distance range, the terminal scales up display content, or scales up a display font based on a preset condition. Refer to Table 3 below:

TABLE 3

| Relationship between a distance X | |
|---|---|
| (unit: centimeter) between a terminal | |
| screen and a face and a preset distance L | |
| (unit: centimeter) | Display content of a terminal |
| Distance X between the terminal screen | Perform normal display |
| and the face ≤ the preset distance R | |
| Distance X between the terminal screen | Scale up the display content, |
| and the face > the preset distance R | or scale up the display font |

It can be learned from Table 3 that, after the distance X between the terminal screen and the face is obtained, the distance X is compared with the preset distance R configured on the terminal, and when the distance X between the terminal screen and the face is less than or equal to the preset distance R, normal display is performed, to be specific, content that is being displayed on the terminal is displayed. When the distance X between the terminal screen and the face is greater than the preset distance R, display content is scaled up, or a display font is scaled up based on a preset condition.

It can be learned from this that, when the obtained distance X between the terminal screen and the face is within a range of the preset distance R, normal display is performed; and once the distance X between the terminal screen and the face exceeds the preset distance R, the display content is scaled up, or the display font is scaled up. Therefore, this embodiment of the present invention provides convenience for a user, and especially provides convenience for a user with a poor sight. For example, for a far-sighted senior person, when the distance between the terminal screen and the face is beyond the preset distance range, scaling up the display content or scaling up the display font is more beneficial for the user to view content displayed on the terminal.

In another example, when the terminal is in a working mode, if the distance between the terminal screen and the face is within a preset distance range, the terminal performs normal display; or if the distance between the terminal screen and the face is beyond a preset distance range, the terminal reduces display content, or scales down a display font based on a preset condition. Refer to Table 4 below:

TABLE 4

| Relationship between a distance X | |
|---|---|
| (unit: centimeter) between a terminal | |
| screen and a face and a preset distance L | |
| (unit: centimeter) | Display content of a terminal |
| Distance X between the terminal screen | Perform normal display |
| and the face ≤ the preset distance S | |
| Distance X between the terminal screen | Reduce display content, or |
| and the face > the preset distance S | scale down a display font |

It can be learned from Table 4 that, after the distance X between the terminal screen and the face is obtained, the distance X is compared with the preset distance S configured on the terminal, and when the distance X between the terminal screen and the face is less than or equal to the preset distance S, normal display is performed, to be specific, content that is being displayed on the terminal is displayed. When the distance X between the terminal screen and the face is greater than the preset distance S, display content is reduced, or a display font is scaled down based on a preset condition.

It can be learned from this that, when the obtained distance X between the terminal screen and the face is within a range of the preset distance S, normal display is performed; and once the distance X between the terminal screen and the face exceeds the preset distance S, the display content is reduced, or the display font is scaled down. Therefore, this embodiment of the present invention can effectively prevent leakage of personal privacy.

In another example, if the distance between the terminal screen and the face is beyond the preset distance range, the terminal displays normal content; or if the distance between the terminal screen and the face is within the preset distance range, the terminal displays detailed content of the normal content. Table 5 is as follows:

TABLE 5

| Relationship between a distance X | |
|---|---|
| (unit: centimeter) between a terminal | |
| screen and a face and a preset distance L | |
| (unit: centimeter) | Display content of a terminal |
| Distance X between the terminal screen | Perform normal display |
| and the face ≥ the preset distance M | |
| Distance X between the terminal screen | Display more detailed content |
| and the face < the preset distance M | |

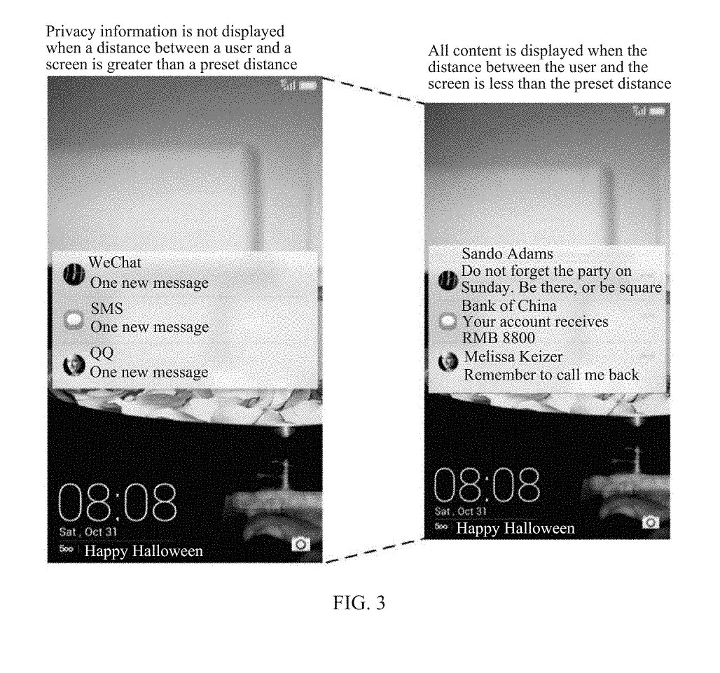

It can be learned from Table 5 that, after the distance X between the terminal screen and the face is obtained, the distance X is compared with the preset distance M configured on the terminal, and when the distance X between the terminal screen and the face is greater than or equal to the preset distance M, normal display is performed, to be specific, content that is being displayed on the terminal is displayed. When the distance X between the terminal screen and the face is less than the preset distance M, more detailed content is displayed, to be specific, more detailed content of content that is being displayed on the terminal is displayed. Refer to FIG. 3.

To be specific, when it is obtained that the distance X between the terminal screen and the face is beyond the range of the preset distance M, normal display is performed; and once the distance X between the terminal screen and the face is less than the preset distance M, more detailed content is displayed. Therefore, this embodiment of the present invention provides convenience for a user, helping the user learn of new information.

In FIG. 3, the left picture is content normally displayed on the intelligent terminal, and the right picture is more detailed content of the normally displayed content. A person skilled in the art may understand that, the left picture and the right picture in FIG. 3 are only an example of a picture of a lock screen interface of the intelligent terminal.

In the left picture in FIG. 3, when the distance X between the terminal screen and the face is beyond the range of the preset distance M, the terminal performs normal display, and a manner of the normal display is as follows: when there is anew message, the lock screen interface of the intelligent terminal only prompts that there is a new message. Specifically, when there is a new message in WeChat, the lock screen interface of the intelligent terminal only displays “One new message” under the WeChat icon; when there is a new message in the short message service, the lock screen interface of the intelligent terminal only displays “One new message” under the short message service icon; when there is a new message in QQ, the lock screen interface of the intelligent terminal only displays “One new message” under the QQ icon. In the right picture in FIG. 3, when the distance X between the terminal screen and the face is within the range of the preset distance M, the terminal displays more detailed content of the normal content. For example, the more detailed content is as follows: When there is a new message in WeChat, the lock screen interface of the intelligent terminal displays, under the WeChat icon, a new message sent by the friend “Sando Adams”, and specific content of the message is “Do not forget the party on Sunday”; when there is anew message in the short message service, the lock screen interface of the intelligent terminal displays, under the short message service icon, a new message sent by “Bank of China”, and specific content of the message is “Your account receives RMB 8800”; when there is a new-message m QQ, the lock screen interface of the intelligent terminal displays, under the QQ icon, a new message sent by “Melissa Keizer”, and specific content of the message is “Remember to call me back”.

In an example, a specific display manner of the “more detailed content” may be configured. For example, whether more detailed information needs to be displayed for a message such as a short message service message, a WeChat message, or a QQ message on the lock screen interface may be implemented by configuring the manner. Specifically, refer to the following Table 6.

TABLE 6

| Relationship between a distance X | |
|---|---|
| (unit: centimeter) between a terminal | |
| screen and a face and a preset | |
| distance L (unit: centimeter) | Display content of a terminal |
| Distance X between the terminal screen | Perform normal display |
| and the face ≥ the preset distance M | |
| Distance X between the terminal screen | Display detailed content of |
| and the face < the preset distance M | WeChat or the short message |
| | service |

It can be learned from Table 5 and Table 6 that, in this embodiment of this application, the “more detailed content” is displayed only when the distance between the terminal screen and the face distance is within a range, and therefore a privacy of the terminal user is protected.

In another example, if the distance between the terminal screen and the face is less than a first preset distance, the terminal displays the first content; if the distance between the terminal screen and the face is greater than the first preset distance and less than a second preset distance, the terminal displays the second content; or if the distance between the terminal screen and the face is greater than the second preset distance, the terminal displays third content, where the first content, the second content, and the third content are at least partially different. Table 7 is as follows:

TABLE 7

| Relationships between a distance X | |
|---|---|
| (unit: centimeter) between a terminal | |
| screen and a face and preset distances | Display content |
| T1 and T2 (unit: centimeter) | of a terminal |
| Distance X between the terminal screen | Display first content |
| and the face ≤ First preset distance T1 | |
| First preset distance T1 < Distance X | Display second content |
| between the terminal screen and the | |
| face ≤ Second preset distance T2 | |
| Distance between the terminal screen | Display third content |
| and the face > Second preset distance T2 | |

It can be learned from Table 7 that, after the distance X between the terminal screen and the face is obtained, the distance X is compared with the first preset distance T1 configured on the terminal, and when the distance X between the terminal screen and the face is less than or equal to the first preset distance T1, the first content is displayed; when the distance X between the terminal screen and the face is greater than the first preset distance T1 and is less than or equal to the second preset distance T2, the second content is displayed; when the distance X between the terminal screen and the face is greater than the second preset distance T2, the third content is displayed.

It needs to be noted that, a quantity of preset distances in Table 7 is not limited to two, in other words, the preset distances are not limited to T1 and T2; and the quantity of preset distances and specific values of the preset distances may be configured. For example, there are three preset distances, respectively T1, T2, and T3, and when the distance X between the terminal screen and the face is less than or equal to the first preset distance T1, the first content is displayed; when the distance X between the terminal screen and the face is greater than the first preset distance T1 and is less than or equal to the second preset distance T2, the second content is displayed; when the distance X between the terminal screen and the face is greater than the second preset distance T2 and is less than or equal to the third preset distance T3, the third content is displayed: when the distance X between the terminal screen and the face is greater than the third preset distance T3, fourth content is displayed.

Therefore, in this embodiment of this application, a plurality of preset distances are set, and different information are displayed within different preset distance ranges, thereby making terminal display more entertaining and improving user experience. In an application scenario, for a user performing monotonous work with a personal computer, a plurality of preset distances are displayed for a desktop of the personal computer, and different desktop content is displayed for different preset distances, thereby making personal computer use more entertaining.

In another example, if one or more faces are detected, if it is determined that at least one of all the faces matches one or more preset faces, normal display is performed; and if it is determined that no face matches one or more preset faces, the corresponding content is displayed based on the preset condition.

In still another example, before the detecting a distance between a terminal screen and a face, that is, before step 140, the method includes: detecting whether there are one or more faces, if detecting that there are one or more faces, determining whether at least one of all the faces matches the one or more preset faces, and if at least one of all the faces matches the one or more preset faces, performing the detecting a distance between a terminal screen and a face, that is, performing step 140; otherwise, displaying the corresponding content based on the preset condition.

In another example, after the detecting a distance between a terminal screen and a face, that is, after step 140, the method includes: if detecting that the distance between the terminal screen and the face is within the preset distance range, determining whether at least one of all the faces matches the one or more preset faces, and if at least one of all the faces matches the one or more preset faces, performing normal display; or if determining that no face matches the one or more preset faces, displaying the corresponding content based on the preset condition.

In still another example, after the detecting a distance between a terminal screen and a face, that is, after step 140, the distance between the terminal screen and the face is detected, when the distance is within the preset distance range, whether at least one face matches the one or more preset faces is determined, and if it is determined that no face matches the one or more preset faces, the corresponding content is displayed based on the preset condition; or if at least one face matches the one or more preset faces, the distance between the face and the terminal screen is determined, and if the distance is within the preset distance range, normal display is performed; or if the distance is beyond the preset distance range, the corresponding content is displayed based on the preset condition.

It needs to be noted that, the preset distances in Table 1 to Table 7 may be configured, and the display manner of the terminal may be any one display manner or a combination of any multiple display manners in Table 1 to Table 7, or may be another display manner. Any detecting the distance between the terminal screen and the face and displaying different content based on a difference of the range of the distance between the terminal screen and the face (in other words, based on the relationships between the distance between the terminal screen and the face and the preset distances) falls within the protection scope of this application.

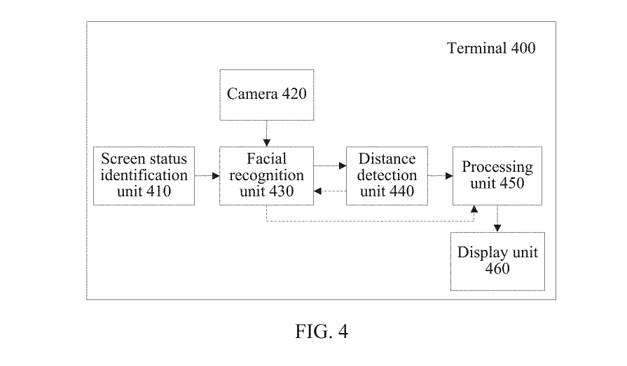

FIG. 4 is a schematic diagram of a terminal according to an embodiment of this application. The terminal 400 includes a screen status identification unit 410, a camera 420, a facial recognition unit 430, a distance detection unit 440, a processing unit 450, and a display unit 460.

The screen status identification unit 410 is configured to: detect whether a screen of the terminal is on and start, in a screen-on state of the terminal screen, the facial recognition unit 430 disposed on the terminal.

The camera 420 is configured to capture an image that squarely faces the terminal screen, for example, a front camera on the terminal.

The facial recognition unit 430 is configured to recognize whether the image captured by the camera 420 includes a face.

The distance detection unit 440 detects a distance between the terminal screen and the face when the facial recognition unit 430 recognizes that the image captured by the camera 420 is a face.

In an example, the distance detection unit 440 is a sensor.

Further, the sensor is a ranging sensor or a displacement sensor. For example, the distance detection unit 440 is a ranging sensor, and the ranging sensor detects a distance to an obstacle, thereby obtaining the distance between the face and the terminal screen.

Further, the sensor is an infrared ranging sensor, an ultrasonic sensor, a laser ranging sensor, or the like.

In an example, when the facial recognition unit 430 detects that the image obtained by the camera 420 includes a plurality of faces, the distance detection unit 440 is configured to: calculate a distance between each face and the terminal screen, and use a minimum distance value as the distance between the terminal screen and the face.

The processing unit 450 is configured to: display first content when determining that the distance between the terminal screen and the face satisfies a first distance condition; and display second content when determining that the distance between the terminal screen and the face satisfies a second distance condition, where the first content and the second content are at least partially different.

In an example, the processing unit 450 is specifically configured to: when the terminal is in a working mode or a lock screen mode, if the distance between the terminal screen and the face is within a preset distance range, determine that the terminal performs normal display; or if the distance between the terminal screen and the face is beyond a preset distance range, determine that the terminal displays corresponding content based on a preset condition.

In another example, the processing unit 450 is specifically configured to: when the terminal is in a working mode or a lock screen mode, if the distance between the terminal screen and the face is within a preset distance range, perform, by the terminal, normal display; or if the distance between the terminal screen and the face is beyond a preset distance range, reduce a display content, reduce display brightness, or reduce a display resolution based on a preset condition. In another example, the processing unit 450 is specifically configured to: when the terminal is in a working mode, if the distance between the terminal screen and the face is within a preset distance range, perform, by the terminal, normal display; or if the distance between the terminal screen and the face is beyond a preset distance range, scale up display content or scale up a display font based on a preset condition.

In another example, the processing unit 450 is specifically configured to: when the terminal is in a working mode, if the distance between the terminal screen and the face is within a preset distance range, perform, by the terminal, normal display; or if the distance between the terminal screen and the face is beyond a preset distance range, scale down display content or scale down a display font based on a preset condition.

In another example, the processing unit 450 is specifically configured to: when the distance between the terminal screen and the face is beyond a preset distance range, determine that the terminal performs normal display; or if the distance between the terminal screen and the face is within a preset distance range, determine that detailed content is displayed.

In still another example, the processing unit 450 is specifically configured to: when the distance between the terminal screen and the face is less than a first preset distance T1, determine that the terminal displays the first content; when the distance between the terminal screen and the face is greater than the first preset distance T1 and less than a second preset distance T2, determine that the terminal displays the second content; or when the distance between the terminal screen and the face is greater than the second preset distance T2, determine that the terminal displays third content, where the first content, the second content, and the third content are at least partially different.

The display unit 460 is configured to display information based on the display content determined by the processing unit 450. For example, the display unit 460 is a liquid crystal display screen, or an LED display screen.

An embodiment of the present invention further provides a graphical user interface on an electronic terminal. The electronic terminal includes a display screen, one or more user input devices, a memory, and one or more processors configured to perform one or more programs stored in the memory. The graphical user interface includes that:

a distance between a face of a user of the electronic terminal and the electronic terminal display screen is detected; and

in response to detecting the distance, first content is displayed on the display screen when it is determined that the distance satisfies a first preset condition; and second content at least partially different from the first content is displayed on the display screen when it is determined that the distance satisfies a second preset condition.

In an example, display scales or display fonts of the first content and the second content are different.

Parameters mentioned in this application, such as X, M, R, L, and N, are all integers.

The foregoing describes a data sending method in the embodiments of this application. A person skilled in the art is aware that the method embodiment and each step process can be implemented in a hardware manner. The person skilled in the art can construct corresponding modules and make variations based on the foregoing method embodiments, and these modules and variations shall fail within the protection scope of this application. Details are not described herein.

The person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. The person skilled in the art may use different methods to implement the described functions for each particular application, but it should not be considered that the implementation goes beyond the scope of this application.

The steps in the method or algorithm described in the embodiments disclosed in this specification may be implemented by hardware, software module executed by the processor, or combination of hardware and software. The software module may reside in a random-access memory (RAM), a mam memory, a read-only memory (ROM), an electrically programmable ROM, an electrically erasable programmable ROM, a register, a hard disk, a removable disk, a CD-ROM, or any other form of storage medium known in the art.

In the foregoing specific implementations, the objective, technical solutions, and benefits of this application are further described in detail. It should be understood that the foregoing descriptions are merely specific implementations of this application, but are not intended to limit the protection scope of this application. Any modification, equivalent replacement, or improvement made without departing from the spirit and principle of this application should fall within the protection scope of this application.

1. An information display method, the method performed by an electronic terminal, and the method comprising:
detecting a distance between a terminal screen and a face;
displaying first content when the distance between the terminal screen and the face satisfies a first distance condition; and
displaying second content when the distance between the terminal screen and the face satisfies a second distance condition, the first content and the second content being at least partially different.

2. The method of claim 1, wherein the electronic terminal is in a working mode, and before detecting the distance between the terminal screen and the face, the method further comprising:
providing a user with a setting for enabling and disabling a function of detecting the distance between the terminal screen and the face; and
displaying different content based on different distances.

3. The method of claim 1, wherein the electronic terminal is in a working mode or a lock screen mode, and displaying the first content and the second content comprising:
performing normal display when the distance between the terminal screen and the face is within a preset distance range; and
displaying corresponding content based on a preset condition when the distance between the terminal screen and the face is beyond the preset distance range.

4. The method of claim 1, wherein the electronic terminal is in a working mode or a lock screen mode, and displaying the first content and the second content comprising:
performing normal display when the distance between the terminal screen and the face is within a preset distance range; and
reducing display content, reducing display brightness, or reducing a display resolution based on a preset condition when the distance between the terminal screen and the face is beyond the preset distance range.

5. The method of claim 1, wherein the electronic terminal is in a working mode, and displaying the first content and the second content comprising:
performing normal display when the distance between the terminal screen and the face is within a preset distance range; and
scaling up display content or scaling up a display font based on a preset condition when the distance between the terminal screen and the face is beyond the preset distance range.

6. The method of claim 1, wherein the electronic terminal is in a working mode, and displaying first content and the second content comprising:
performing normal display when the distance between the terminal screen and the face is within a preset distance range; and
scaling down display content or scaling down a display font based on a preset condition when the distance between the terminal screen and the face is beyond the preset distance range.

7. The method of claim 1, wherein displaying, the first content and the second content comprises:
displaying the first content when the distance between the terminal screen and the face is less than a first preset distance;
displaying the second content when the distance between the terminal screen and the face is greater than the first preset distance and less than a second preset distance; and
displaying third content when the distance between the terminal screen and the face is greater than the second preset distance, the first content, the second content, and the third content being at least partially different.

8. The method of claim 1, wherein detecting distance between the terminal screen and the face comprises: detecting the distance between the terminal screen and the face using a proximity sensor or a displacement sensor.

9. The method of claim 1, wherein there is a plurality of faces, and detecting the distance between the terminal screen and the face comprising:
calculating a distance between each face and the terminal screen; and
setting a minimum distance value as the distance between the terminal screen and the face.

10. The method according to claim 1, wherein there are one or more faces, and the method further comprising:
performing normal display when at least one of one or more faces matches one or more preset faces; and
displaying corresponding content based on a preset condition when no face matches the one or more preset faces.

11. The method according of claim 1, wherein before detecting the distance between the terminal screen and the face, the method further comprises:
detecting whether there are one or more faces;
determining whether at least one of the one or more faces matches one or more preset faces when detecting that there are the one or more faces;
detecting the distance between the terminal screen and the face when at least one of the one or more faces matches the one or more preset faces; and
displaying corresponding content based on a preset condition when not face matches the one or more preset faces.

12. The method of claim 1, wherein after detecting the distance between the terminal screen and the face, the method further comprises:
determining whether at least one of one or more faces matches one or more preset faces when detecting that the distance between the terminal screen and the face is within a preset distance range;
performing normal display when the at least one of the one or more faces matches the one or more preset faces; and
displaying corresponding content based on a preset condition when no face matches the one or more preset faces.

13. A terminal, comprising:
a terminal screen;
a memory storage comprising instructions; and
one or more processors in communication with the terminal screen and the memory storage, the instructions causing the one or more processors to be configured to:
detect a distance between the terminal screen and a face;
display first content when the distance between the terminal screen and the face satisfies a first distance condition; and
display second content when determining that the distance between the terminal screen and the face satisfies a second distance condition, the first content and the second content being at least partially different.

14. The terminal of claim 13, wherein the terminal is in a working mode or a lock screen mode, and the instructions further causing the one or more processors to be configured to:
determine that the terminal performs normal display when the distance between the terminal screen and the face is within a preset distance range; and
determine that the terminal displays corresponding content based on a preset condition when the distance between the terminal screen and the face is beyond the preset distance range.

15. The terminal of claim 13, wherein the terminal is in a working mock or a lock screen mode, and the instructions further causing the one or more processors to be configured to:
perform normal display when the distance between the terminal screen and the face is within a preset distance range; and
reduce display content, reduce display brightness, or reduce a display resolution based on a preset condition when the distance between the terminal screen and the face is beyond the preset distance range.

16. The terminal of claim 13, wherein the terminal is in a working mode, and the instructions further causing the one or more processors be configured to:
perform normal display when the distance between the terminal screen and the face is within a preset distance range; and
scale up display content or scale up a display font based on a preset condition when the distance between the terminal screen and the face is beyond the preset distance range.

17. The terminal of claim 13, wherein the terminal is in a working mode, and the instructions further causing the one or more processors to be configured to:
perform normal display when the distance between the terminal screen and the face is within a preset distance range; and
scale down display content or scale down a display font based on a preset condition if when the distance between the terminal screen and the face is beyond the preset distance range.

18. The terminal of claim 13, wherein the instructions further cause the one or more processors to be configured to:
determine that the terminal displays the first content when the distance between the terminal screen and the face is less than a first preset distance;
determine that the terminal displays the second content when the distance between the terminal screen and the face is greater than the first preset distance and less than a second preset distance; and
determine that the terminal displays third content when the distance between the terminal screen and the face is greater than the second preset distance, the first content, the second content, and the third content being at least partially different.

19. The terminal of claim 13, wherein there is a plurality of faces, and the instructions further causing the one or more processors to be configured to:
calculate a distance between each face and the terminal screen; and
set a minimum distance value as the distance between the terminal screen and the face.

20.-21. (canceled)

22. The method of claim 1, wherein the electronic terminal is in a working mode, and before detecting the distance between the terminal screen and the face, the method further comprising:
providing a user with a setting for enabling and disabling a function, in one or more mobile phone applications, of detecting the distance between the terminal screen and the face; and
displaying different content based on different distances.
